(19) United States
(12) Patent Application Publication
(10) Pub. No.: US 2014/0095201 A1
(43) Pub. Date: Apr. 3, 2014

(54) Leveraging Public Health Data for Prediction and Prevention of Adverse Events

(71) Applicants: Faisal Farooq, Norristown, PA (US); Balaji Krishnapuram, King of Prussia, PA (US); Glenn Fung, Madison, WI (US); Shipeng Yu, Exton, PA (US); Karen Nielsen, Havertown, PA (US)

(72) Inventors: Faisal Farooq, Norristown, PA (US); Balaji Krishnapuram, King of Prussia, PA (US); Glenn Fung, Madison, WI (US); Shipeng Yu, Exton, PA (US); Karen Nielsen, Havertown, PA (US)

(73) Assignee: SIEMENS MEDICAL SOLUTIONS USA, INC., Malvern, PA (US)

(21) Appl. No.: 14/032,522

(22) Filed: Sep. 20, 2013

Related U.S. Application Data
(60) Provisional application No. 61/707,243, filed on Sep. 28, 2012.

(51) Int. Cl. G06F 19/00

(52) U.S. Cl. CPC G06F 19/3431
USPC 705/3

(57) ABSTRACT

An adverse event may be prevented by predicting the probability of a given patient to have or undergo the adverse event. The ability to predict the probability of the adverse event may be enhanced when a model is derived from public health data to categorize and propose values for medical record fields. The probability alone may prevent the adverse event by educating the patient or medical professional. The probability may be predicted at any time, such as upon entry of information for the patient, periodic analysis, or at the time of admission. The probability may be used to generate a workflow action item to reduce the probability, to warn, to output appropriate instructions, and/or assist in avoiding adverse event. The probability may be specific to a hospital, physician group, or other medical entity, allowing prevention to focus on past adverse event causes for the given entity.

### RELATED APPLICATIONS

The present patent document claims the benefit of the filing date under 35 U.S.C. §119(e) of Provisional U.S. Patent Application Ser. No. 61/707,243, filed Sep. 28, 2012, which is hereby incorporated by reference in its entirety.

### BACKGROUND

The present embodiments relate to predicting risk of adverse events in healthcare patients and/or providing valuable information to potentially prevent adverse events. Preventing adverse events at medical facilities or for patients previously treated at the medical facility may reduce medical costs and may benefit the patient and medical facility.

Various adverse events may occur for a patient of a medical facility. For example, a patient acquires a hospital acquired infection (HAI). HAIs, also known as nosocomial infection or healthcare-associated infection, are infections that first appear within 48 hours post-admission or 30 days after a patient is discharged from a hospital or other health-care facility. These infections do not originate from a patient's original admitting diagnosis. Examples of nosocomial infections include methicillin resistant Staphylococcus aureus (MRSA), hospital-acquired pneumonia (HAP), tuberculosis, urinary tract infection, and gastroenteritis. The Center for The Centers for Disease Control and Prevention (CDC) estimates that roughly 1.7 million HAIs cause or contribute to 99,000 deaths each year, with the annual cost ranging from $4.5 billion to $11 billion. In Europe, the incidence of HAI is nearly 10% and ranges from 5-15% in the rest of the world. In addition, the CDC estimates that more than 36% of these infections are preventable.

Another adverse event associated with current or former patients of a medical facility is patient falls. About 30% of patients over 65 years of age fall each year and only half of them survive after a year of the fall. The risk of a patient falling depends on various factors, like whether the patient needs an assistive device (e.g., a cane, walker, or prosthesis), an unsteady gait due to joint problems, pain, dizziness, or balance compromise, or whether the patient is taking specific medications like antihistamines, cathartics, diuretics, or narcotics. The Hendrich Fall Risk Model is used to assess a hospitalized patient's risk of falling. Designed to be administered quickly, it focuses on eight independent risk factors: confusion, disorientation, and impulsivity; symptomatic depression; altered elimination; dizziness or vertigo; male sex; administration of antiepileptics (or changes in dosage or cessation); administration of benzodiazepines; and documented poor performance in rising from a seated position. However, the model may miss important factors or may not be applied.

Another example adverse event is a patient reaction to a contrast agent administered at a medical facility for medical imaging. Patients undergoing computed tomography (CT) scans, angiography, or magnetic resonance (MR) often receive contrast agents. Many possible complications may arise from the use of contrast agents. For example if the patient is allergic to the contrast agent, severe life threatening outcomes may arise. More frequently, if the patient has poor renal function, the use of contrast agents may further damage the kidney or the contrast agents may not be cleared from the body rapidly enough. Iodine contrast for CT and angiography may result in a condition known as contrast induced nephropathy (CIN). Gadolinium-based contrast agents for MR sometimes result in nephrogenic systemic fibrosis (NSF).

Contrast agent related adverse events have drawn widespread attention from researchers and physicians. The American College of Radiology (ACR) and other such bodies worldwide have established guidelines requiring that the patient's history be evaluated for risk factors, and that lab tests be conducted to evaluate renal function before administering contrast agents for radiological studies. Unfortunately, adherence to these guidelines remains poor in practice, and patients often do not receive the appropriate lab tests. Even if these tests are conducted, their results may not be appropriately reviewed for the risk to the patient before the radiological procedure is performed. Further, other risk factors, such as poor hydration and history of diabetes, are not always evaluated before the procedure even though recommended by the ACR.

Yet another event that may be considered an adverse event for medical entities is the readmission of former patients. In the United States, about 20% of all Medicare beneficiaries are readmitted, out of which 75% of the readmissions are potentially preventable. Examples of this include admission for angina following discharge for percutaneous transluminal coronary angioplasty (PTCA) or admission for trauma following discharge for Acute Myocardial Infarction (AMI). The government and other private payers are focusing on controlling the costs associated with readmission. Preventable readmission costs may amount to nearly $12 billion annually. The Center for Medicare and Medicaid Services (CMS) currently mandates public reporting of readmission rates and payers may institute financial penalties for poor performance and/or rewards for low readmissions. Due to a paradigm shift towards accountable care, organizations are focusing on cost reduction, standardized care, and quality improvement. There is a large, growing need to help hospitals reduce preventable rate of readmissions to improve quality of care and avoid financial and legal implications. Many of these preventable readmissions are caused by discrepancies in personal health records that have not been updated with previous or current admissions, medications (pre and post admission) not reconciled at the time of discharge, and no proper follow up with physicians or nurses.

A significant amount of public information is also now available relating to societal characteristics of a population. The public health sector has collected a considerable amount of data across a variety of health domains, mainly for reporting and planning purposes. Most of the data reported by the public health sector involves combined information for a population such that no individual information is released. Public data for a population may then be differentiated from private data which can indicate a specific individual.

### SUMMARY

In various embodiments, systems, methods and computer readable media are provided for predicting or preventing the adverse events associated with current and past patients of a medical entity. An adverse event may be prevented by predicting the probability of a given patient to have or undergo the adverse event. The ability to predict the probability is enhanced by the inclusion of public health data, which is used to generate a model that may propose values for a patient based on a category to which the patient belongs. The proposed values may be used in combination with existing patient health data to predict the probability.

A probability alone may prevent the adverse event by educating the patient or medical professional. The probability may be predicted at any time, such as upon entry of information for the patient, periodic analysis, at the time of admission, or at discharge. The probability may be used to generate a workflow action item to reduce the probability, to warn, to output appropriate instructions, and/or assist in avoiding adverse event during or after the patient stay. The probability may be specific to a hospital, physician group, or other medical entity, allowing prevention to focus on past adverse event causes for the given entity.

In a first aspect, a method is provided for predicting or preventing medical entity-related adverse events. Identifying a societal factor associated with a patient is performed by using a processor to apply a category risk model. The category risk model links the societal factor to a probability of occurrence of an adverse event. Assigning the patient to a category based on the societal factor, and determining a category probability of the occurrence of the adverse event based on the category may also be performed by the processor applying the category risk model. Determining, a medical probability of an occurrence of the adverse event from an electronic medical record of characteristics of the patient may be performed using a processor applying a medical risk model. The medical probability is based on adverse event data of other patients of the medical entity. Determining a patient specific probability of an occurrence of the adverse event to the patient based on the category probability and the medical probability may then be performed by the processor.

In a second aspect, a system is provided for predicting or preventing adverse events. At least one memory is operable to store data for a plurality of patients of a medical entity. A first processor is configured to identify information of a patient related to a societal factor and categorize the patient based on the societal factor indicated by a category risk model as affecting a probability of an occurrence of an adverse event. The first processer is configured to assign a category probability of the occurrence of the adverse event based on the category. The first processor is configured to calculate a medical probability of an occurrence of the adverse event based on an electronic medical record of characteristics of the patient and data of other patients of the medical entity. The first processor is configured to predict a patient specific probability of an occurrence of the adverse event to the patient based on the category probability and the medical probability.

In a third aspect a non-transitory computer readable storage medium having stored therein data representing instructions executable by a programmed processor for predicting or preventing adverse events associated with a medical entity. The storage medium includes instructions for determining a category for a patient based on societal information of a patient. The storage medium includes instructions for calculating a probability of an occurrence of an adverse event based on an electronic medical record of characteristics of the patient and data of a plurality of patients of the medical entity, each of the plurality being assigned to the category. The storage medium includes instructions for comparing the probability to a threshold, and generating an alert based on the comparing, the generating occurring during a patient stay with the medical entity.

Any one or more of the aspects described above may be used alone or in combination. These and other aspects, features and advantages will become apparent from the following detailed description of preferred embodiments, which is to be read in connection with the accompanying drawings. The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

FIG. 1 is a flow chart diagram of one embodiment of a method for predicting or preventing an adverse event;

FIG. 2 is a block diagram of one embodiment of a computer processing system for predicting or preventing an adverse event;

FIG. 3 shows an exemplary data mining framework for mining clinical information; and

FIG. 4 shows an exemplary computerized patient record (CPR).

### DESCRIPTION OF PREFERRED EMBODIMENTS

This disclosure relates to methods and systems for leveraging public health data for risk stratification and integration with healthcare systems to predict or prevent adverse events.

A majority of adverse event cases may be prevented if the risk of the adverse event is established as early as possible. The risk of the adverse event is calculated from the patient records (e.g., clinical, financial, and demographic) and public information sources relating to societal health characteristics (e.g., geographic cancer clusters, socioeconomic status, follow-up care availability, income levels relating to medication availability, disease prevalence in particular geographic regions, or disease prevalence amongst certain ethnic groups). For medical entity-specific adverse events, the risk is calculated by a classifier based on past patient data for the medical institution. For a current patient, the system identifies whether the patient is at risk for the adverse event. The risk is automatically calculated using a predictive model which may be augmented by proposed values. The possible reasons for risk of a particular patient may be identified, and a plan for mitigating the risk may be presented.

As promoted by Healthcare Reform directives, such as the Affordable Care Act in the United States, disease risk stratification for patients is becoming very important in many applications, such as in-hospital risks of HAI/HAC, mortality and readmissions, population level risk analysis for population management, disease management and disease prevention. Risk stratification models may be built manually or derived from historical data. Generally, the historical data is private sector data (e.g. hospital or provider specific). However, public sector data may also be used to further develop risk stratification models. Both public sector data and private sector data may be used together or separately to develop medical entity and population specific risk stratification models. Risk stratification models may be used in the prediction and prevention of adverse events.

In data-driven risk stratification approaches, all collected information related to patient populations may be utilized to build risk stratification models. Electronic Medical Record (EMR) systems may provide much of this data. There may be insufficient data from an EMR system to fully develop a risk stratification model. An example of this is a general model for readmission risk stratification. A socioeconomic status or category for a patient is important for predicting readmission risk for the patient to the medical entity. This data is typically not stored for individual patients in an EMR system. However, address data for a patient typically is included in an EMR system. Also, public health agencies may report socioeconomic data at national, state, county, or even neighborhood levels. Therefore, the combination of the address data for the patient and the socioeconomic data may provide a correlation to an inference about the socioeconomic category of the patient, thereby potentially improving the accuracy of a readmission risk stratification model finding for the patient. The risk stratification model may output the finding as a probability of readmission of the patient.

In an embodiment, public health information identified as relevant to a population of interest may be identified. The public health information may be in the form of a scientific government study, or general population social health statistics. Specific information for a patient may then be used to associate the patient with a category of the public health information to extract information from the public health information that may have a high probability of relating to the patient. The public health information may be extracted and associated with the patient in different ways. One way may be to use a value derived as an aggregation of values for a category to which the patient may belong. For example, if 90% of the people that have an address in a 60614 zip code are found to fall into a high salary or earnings category or bracket, and the patient has an address in the 60614 zip code, it may be inferred that the patient is in a high salary or earnings category. This value may be input into an EMR for the patient, used independently, or in combination with other data, to determine a probability that an adverse event will occur with respect to the patient.

The public health data may be extracted in other ways as well. In an embodiment, a sample value based on an aggregated value determined from the public health data may be used. The sample value may be derived from a distribution assumption of the public health data, and correlating data of a patient indicating where in the distribution the patient would be placed.

In another embodiment, existing patient data may be combined with public health data and machine learning techniques may be used to map values from the field for the existing patient data to a specific, or current, patient. Graphical models may be used in such an embodiment.

In another embodiment, the public health data is extracted for a plurality of records in an EMR system. The extracted data may be used to augment the records in an EMR system, as described above for a singular patient, and machine learning techniques may be applied to the augmented EMR system to determine characteristics or categories to aid in adverse event prediction and prevention. A future patient may then be categorized or evaluated for comparative criteria that may indicate an increase or decrease in a probability that the future patient may experience an adverse event.

In another embodiment, a system may be provided to predict or prevent adverse events. The system may involve a public health data extractor that is configured to periodically extract information from public health agencies. A public health data analyzer may also be provided that pre-processes the extracted information from public health agencies and stores the processed extracted information in a memory. The system may involve a risk model component that analyzes information of a new patient, augments the patient characteristics with fields from processed extracted information, applies the risk model to the augmented new patient information, and returns a score indicative of a risk of an adverse event occurring to the new patient. The system may also involve a risk visualization component that displays a risk profile of a population of interest. The risk visualization component may rank the members by their risk scores. The risk visualization component may also show graphs, trends or other graphical forms to further illustrate or display the risk profile of a population of interest.

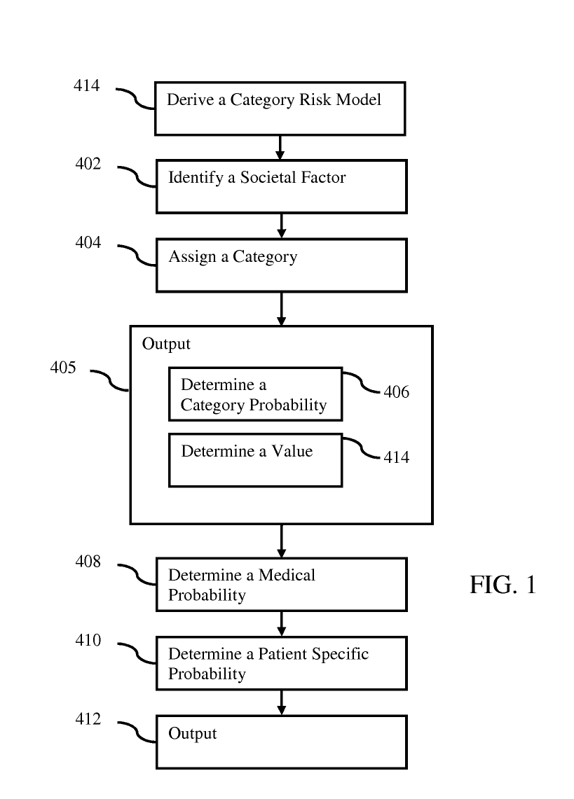

FIG. 1 shows a method for preventing or predicting an adverse event of a patient associated with a medical entity. The method is implemented by or on a processor, such as a processor of a computer, server, or other device. The method is provided in the order shown, but other orders may be provided. Additional, different or fewer acts may be provided. For example, acts 405, 406, and 408, 412 or combinations thereof are not provided. As another example, the determining a category probability of act 406 is not performed.

Continuous (real-time) or periodic prediction of the risk of an adverse event is performed. Throughout the hospital stay, the care provider may tune their care based on the most recent prediction. Given the rise in accountable care where the care provider shares the financial risk, prediction before scheduling discharge, at admission, before treatment, before clinical action, periodically, or at other patient events allows alteration of the care of the patient in such a way that the risk of the adverse event is kept low as the patient progresses on the floor. The risk may be predicted before admission, right at the time the patient is admitted, during a stay of a patient, at discharge, and/or other times. As the time passes and as more data (e.g., new labs results, new medications, new procedures, existing history, or other patient events) is gathered, the risk may be updated continuously for the care provider and/or patient to monitor.

The prediction may be triggered based on data entry. The receipt of data entry is by a computer or processor of the medical entity. A nurse or administrator enters data for the medical record of a patient indicating admission or other patient event. For discharge related examples to attempt to avoid the adverse event after leaving the medical entity, the entry may be doctor instructions to discharge, may be that the patient is being discharged, may be scheduling of discharge, or may be another discharge related entry. As another example of data entry, a new data entry is provided in the electronic medical record of the patient. In another example, an assistant enters data showing admission or other key trigger event (e.g., completion of surgery, assignment of the patient to another care group, or a change in patient status).

In act 402, a societal factor associated with a patient is identified. A category risk model may link the societal factor to a probability of occurrence of an adverse event. A societal factor may be data or information related to the patient that indicates a characteristic, or combination of characteristics, that allows the patient to be categorized relative to their society or relative to other people. The societal factor may not include information that typically relates to patient health. For example, societal factors may include an address or zip code of the patient, an annual income for the patient, or even a wealth value for the patient. The societal factor may be identified or determined from an existing record of the patient, or upon entry of data into a record. This non-health or non-clinical data relates to the patient's position in society rather than to a measure of the patient's body or health function. This non-health or non-clinical data is different than family history, which is directly linked to health risk of the patient by genetics.

The patient is associated with a medical entity, such as being a past or present patient. Any medical entity may provide the data entry, such as a hospital, physician group, doctor's office, group of hospitals, or diagnostic or treatment facility. The medical entity, due to the association with the patient, may be in a position to prevent an adverse event.

The category risk model indicates the societal factor or factors to be used. The societal factor or factors are obtained from or for the patient. For example, manual entry of information is solicited. As another example, an address or other societal factor is mined from or searched for in the medical record of the patient.

In act 404, the patient is assigned to a category based on the societal factor. The category risk model incorporates different risks of adverse event based on different categories. For example, yearly income is linked to a risk scale. To make use of the risk information in the model, the income level (e.g., societal factor) of the patient is determined in order to categorize the patient. Patient address information, such as a zip code, or income information in the medical record of the patient may be used to assign the patient to a category of the category risk model. Information from the medical record of a patient may also be combined with other information to assign a patient to a category. For example, a zip code may indicate a wealth level for a population available from public information. From the public information, a wealth category may be determined for the patient.

The category may be determined using publicly available data, or public health data. In an embodiment, a category may be determined by analyzing the data of a scientific study based on generalized health data. For example, the zip code of a patient may imply a socioeconomic class of the patient based on a study indicating that a high percentage of people in the patient zip code belong to the socioeconomic class.

In an embodiment, a category is assigned to a patient using the category risk model. The category risk model may be composed or derived using public health information in act 414. The public health information may imply categories for patients with particular characteristics. Societal information may imply the existence of the particular characteristics. For example, a zip code may imply a socioeconomic category based on public health data.

In an embodiment, a category risk model may be developed using machine learning techniques as applied to public data, such as public health data. The machine learning techniques may identify combinations of societal data, or combinations of societal data and clinical health related data, that create stronger implications for characteristics that may be used to categorize a patient.

An output is provided in act 405. The output is the category and/or representative (e.g., an average) information that may be used to indicate risk for the category. The output is a value from a classifier, to be input to a classifier, or both.

Since the value is based on the societal information of the patient, the value may be determined from public health data. The output value may also be determined from a combination of public health data and a collection of clinical data for a medical entity, for example, a collection of electronic medical records for patients of a medical entity.

The output value may be a probability of an adverse event based on the category determined in act 404 using the societal information. For example, the category may imply that people of a certain zip code may have a 30% higher risk for a fall during care, for example an elderly population, than the average risk of cancer for a population in general. This probability may be output.

Alternatively or additionally, the output may be a value determined in act 414 for a field in an electronic medical record for the patient, determined from public data representing the category, or public data representing the category as applied to other electronic medical records of a medical entity to extrapolate a value. For example, public health data may indicate that a certain zip code has a 30% higher probability of the occurrence of a heart attack. The zip code information may be applied to electronic medical records of a medical entity to determine an average cholesterol value for patients of the zip code. This average value may be output to a field for the patient, thus augmenting an electronic medical record for the patient.

In an embodiment, a collection of public health data may be analyzed and used to augment electronic medical records of a medical entity with values based on categories implied for the patients of the medical records by the public health data. The socioeconomic class may be related to a probability of adverse risk. For example, a study may indicate that patients below the poverty line are 25% more likely to suffer from an adverse event of a particular type than patients above the poverty line. The value may be an indication of poverty level, income level, or other group membership for the category. This value derived from public health records is added to the electronic medical record of a particular patient. The category is used to determine what value to add for the patient.

In an embodiment, the category information as applied to a specific medical entity is used. A field of an electronic medical record of a patient is updated with information based on a category risk model as applied to a plurality of electronic medical records for patients of the medical entity. The field of the electronic medical record of the patient may be updated based on an aggregated value determined for the category assigned to a patient. The aggregated value may be an average value of a category for a field or another statistical representation of the category for the field, such as a median or a sampled value based on a distribution with a correlating patient value. The aggregated value may be determined from the electronic medical records of previous patients of the medical entity that were determined to be in the same category as the patient. For example, if a collection of data, such as zip code, dietary intake, and exercise levels indicate a heart disease risk category, an average value for blood pressure or cholesterol levels determined from electronic medical records of patients in the category may be input as a value into the electronic medical record of the patient. Other functions than average may be used, such as standard deviation, difference, or median. This input data may or may not be displayed, but may be used for future calculations and determinations of a probability of an adverse event occurrence.

In an embodiment, the comparative information for a patient relative to other patients in the category is determined. The value output for the category to augment an electronic medical record of a patient is extrapolated or interpolated from related patient-specific information. For example, the patient may be in a heart disease risk category, and data may indicate that the patient intakes a particular amount of sodium a day. The values of sodium intake for previous patients of the category may be sorted to align the intake of the patient with the intakes of the previous patients. A value output, or input into the electronic medical record, for the blood pressure of the patient may be determined in act 414 to be a value of a previous patient in the category with similar sodium intake levels. The correlation between sodium intake and blood pressure levels may be determined using public health data for a population.

In an embodiment, a specific value for a field may be determined in act 414 based on machine learned graphical models. A graphical model is a probabilistic model for which a graph denotes the conditional dependence structure between seemingly random variables. Machine learning may be used to determine the dependency structure for variables to be used in graphic models. For example, a machine learning algorithm may be applied to a plurality of electronic medical records in a determined category. Relationships between fields in the electronic medical records may be determined, and displayed graphically. A value based on the displayed connections may be output to a field for a particular patient.

In an embodiment, values for an electronic medical record for a patient may be derived from values for a population in a public health study by aligning common characteristics between the patient and the populations. Public health data may not identify individuals, but may indicate particular values, or statistical distributions of values, for the population studied. The values may be combined with multiple variables or factors to show correlations between the variables or factors. A study may indicate that the value of one factor may correlate to a value, or range of values, for another factor. For example, public health data may indicate that different ranges of physical activity a week may correlate to ranges for cholesterol levels. A value for exercise levels of a patient may correlate to a range or specific value for a cholesterol level that may be output in act 405 and used in act 408 to determine a medical probability, or in act 410 to determine a patient specific probability. Determining the value in act 414 and outputting the value in act 405 allows probability determinations of adverse event prior to waiting for extensive or lengthy test results.

In an embodiment, a category risk model based on public data may also be based on electronic medical records of a medical entity. The characteristics learned from an analysis of public data may be applied to a collection of electronic medical records of a medical entity to determine values of fields in electronic medical records for patients of a category. A range of values for a category may also be determined. Particular data in a patient electronic medical record may indicate where in the range a projected value for the patient would fall.

The value may or may not be displayed. The value may be used for further calculations regarding a probability of an occurrence of an adverse event. For example, the value may be used in act 408 to determine a medical probability, or in act 410 to determine a patient specific probability. The electronic medical records of the medical entity may have previously been augmented with the public health data, or values from public health data.

The output may also be both a category probability determined in act 406 and the value determined in act 414.

In act 406, a category probability of the occurrence of an adverse event is determined based on the category assigned in step 404. The category probability may be output in act 405. For example, a scientific study may determine that people of a particular socioeconomic category have a higher probability of being readmitted to a hospital. Another societal study may determine that a high percentage of people living in a particular zip code belong to the particular socioeconomic category. Combining this data implies that people living in the particular zip code have a higher probability of readmission to the hospital. A patient with the particular zip code may have a category probability score determined based on the socioeconomic category implied by the zip code of the patient. Further, an additional value from the patient electronic medical record may indicate a probability of readmittance for the patient relative to a category average. For example, a patient may have a blood pressure value higher than the average blood pressure for the category of the patient. This additional value may indicate that the patient has a higher probability of readmittance proportional to the amount the patient blood pressure is higher than the average blood pressure for the category. A patient blood pressure 10% higher than the average for the category may indicate a probability of readmittance 20% higher than the average for the category.

In other embodiments, the category probability is incorporated into the patient specific probability prediction. Rather than determining a specific category probability, the aggregate information based on the category is used in the patient specific probability prediction.

In act 408, a medical probability of an occurrence of an adverse event from is determined from an electronic medical record of characteristics of a patient. Clinical data is used to predict the occurrence of the adverse event (e.g., age, type of illness, sex, and measure of stability used to predict chance of fall).

The medical probability is independent of the societal probability. The address, income level, or other societal factor is not used in the medical probability prediction. Alternatively, the societal factor or an aggregate value determined from the societal factor are used in the medical probability prediction.

The medical probability is determined using a medical risk model. The medical probability may be based on adverse event data of other patients of the medical entity. Using machine-learning, a study, and/or other modeling, historical information for other patients of the medical entity and/or other patients of other medical entities is used to map input values to an output probability. The model indicates determinative variables used to predict the medical probability.

A medical probability for a patient may be determined based on data derived from mining the electronic medical record of the patient. The record of the patient is mined for values for the determinative variables. Mining the medical record of a patient may also identify societal risk factors of the patient used to predict the probability based on societal information.

The electronic medical record for a patient is a single database or a collection of databases. The record may include data at or from different medical entities, such as data from a database for a hospital and data from a database for a primary care physician whether affiliated or not with the hospital. Data for a patient may be mined from different hospitals. Different databases at a same medical entity may be mined, such as mining a main patient data system, a separate radiology system (e.g., picture archiving and communication system), a separate pharmacy system, a separate physician notes system, and/or a separate billing system. Different data sources for the same and/or different medical entities are mined. Alternatively, a single data source is mined.

The data sources have a same or different format. The mining is configured for the formats. For example, one, more, or all of the data sources are of structured data. The data is stored as fields with defined lengths, text limitations, or other characteristics. Each field is for a particular variable. The mining searches for and obtains the values from the desired fields. As another example, one, more, or all of the data sources are of unstructured data. Images, documents (e.g., free text), or other collections of information without defined fields for variables is unstructured. Physician notes may be grammatically correct, but the punctuation does not define values for specific variables. The mining may identify a value for one or more variables by searching for specific criteria in the unstructured data.

Any now known or later developed mining may be used. For example, the mining is of structured information. A specific data source or field is searched for a value for a specific variable. As another example, the values for variables are inferred. The values for different variables are inferred by probabilistic combination of probabilities associated with different possible values from different sources. Each possible value identified in one or more sources are assigned a probability based on knowledge (statistically determined probabilities or professionally assigned probabilities). The possible value to use as the actual value is determined by probabilistic combination. The probabilities from one or more pieces of evidence supporting each possible value are combined. The possible value with the highest combined probability is selected. The selected values are inferred values for the variables of the feature vector of the predictor of adverse event.

U.S. Pat. No. 7,617,078, the disclosure of which is incorporated herein by reference, shows a patient data mining method for combining electronic medical records for drawing conclusions. This system includes extraction, combination and inference components. The data to be extracted is present in the hospital electronic medical records in the form of clinical notes, procedural information, history and physical documents, demographic information, medication records or other information. The system combines local and global (possibly conflicting) evidences from medical records with medical knowledge and guidelines to make inferences over time.

U.S. Published Application No. 2003/0120458, the disclosure of which is incorporated herein by reference, discloses mining unstructured and structured information to extract structured clinical data. Missing, inconsistent or possibly incorrect information is dealt with through assignment of probability or inference. These mining techniques are used for quality adherence (U.S. Published Application No. 2003/0125985), compliance (U.S. Published Application No. 2003/0125984), clinical trial qualification (U.S. Published Application No. 2003/0130871), and billing (U.S. Published Application No. 2004/0172297). The disclosures of the published applications referenced in the above paragraph are incorporated herein by reference. Other mining approaches may be used, such as mining from only structured information, mining without assignment of probability, or mining without inferring for inconsistent, missing or incorrect information. In alternative embodiments, values are input by a user for applying the predictor without mining.

In act 410, a patient specific probability of an occurrence of the adverse event is determined. The patient specific probability may be based on an output 405 such as a category probability determined in step 406, a value determined in act 414, a medical probability determined in step 408, or any combination of these.

In an embodiment, the medical probability and the patient specific probability are each values ranging from 0% to 100%, such as being between 1-99%. A patient specific probability may also be a value ranging from 0% to 100%.

In an embodiment, the medical probability and the category probability may be relatively weighted to determine a patient specific probability. For example, the category probability may be weighted as 35% of the patient specific probability, and the medical probability may be weighted as 65% of the patient specific probability. The respective scores may be multiplied by the respective percentages, and added to form a total probability score.

In an embodiment, a value determined in step 414 may be used to provide a value relevant for a determination of a patient specific probability in act 410. For example, some clinical tests require days or weeks to receive results. However, a value for the field based on the category of the patient determined in act 414 may be provided as an output 405. The value may be an average value for a category. The value may be a value typically requiring time to determine in clinical analysis, such as a cholesterol level. An average cholesterol level for a category provided as the output 405 provides for a faster, or real time, determination of a probability of an adverse event such as a patient heart attack occuring. The prediction may be later updated once lab results or another update is provided.

In an embodiment, the patient specific probability may be determined using a predictor that is a classifier or model. In one embodiment, the patient specific probability predictor is a machine-trained classifier. The societal and medical probabilities are input values or features. Three classifiers (e.g., societal, medical, and combination) are used. Alternatively, one model or machine-trained classifier incorporates both societal and personal medical predictions. The medical and societal values or features are input to output a given patient specific probability. This model incorporates the societal and medical probability predictions into a single classifier. In another alternative, two classifiers are used, one for outputting the societal probability or the medical probability, and the other for using the output probability and other input features to determine the patient specific probability based on both societal-based public health information and patient-specific medical information.

For learning-based approaches, the classifier is taught to distinguish based on features. For example, a patient specific probability model algorithm selectively combines features into a strong committee of weak learners based on values for available variables. As part of the machine learning, some variables are selected as features and others are not selected as features. Those variables with the strongest or sufficient correlation or causal relationship to the occurrence of the adverse event are selected and variables with little or no correlation or causal relationship are not selected. Features that are relevant to the adverse event are extracted and learned in a machine algorithm based on the ground truth of the training data, resulting in a probabilistic model. Any size pool of features may be extracted, such as tens, hundreds, or thousands of variables. The pool is determined by a programmer and/or may include features systematically determined by the machine. The training determines the most determinative features for a given classification and discards lesser or non-determinative features. The training may be forced to maintain one or more features even if not as determinative, and/or discard one or more of the most determinative features.

Any machine learning, or training, may be used, such as training a statistical model (e.g., Bayesian network). The machine-trained classifier is any one or more classifiers. A single class or binary classifier, collection of different classifiers, cascaded classifiers, hierarchal classifier, multi-class classifier, model-based classifier, classifier based on machine learning, or combinations thereof may be used. Multi-class classifiers include CART, K-nearest neighbors, neural network (e.g., multi-layer perceptron), mixture models, or others. A probabilistic boosting tree may be used. Error-correcting output code (ECOC) may be used. In one embodiment, the machine-trained classifier is a probabilistic boosting tree classifier. The detector is a tree-based structure with which the posterior probabilities of the adverse event are calculated from given values of variables. The nodes in the tree are constructed by a nonlinear combination of simple classifiers using boosting techniques. The probabilistic boosting tree (PBT) unifies classification, recognition, and clustering into one treatment. Alternatively, a programmed, knowledge based, or other classifier without machine learning is used.

The patient specific probability predictor is trained for predicting one or more adverse events. For example, the machine-trained classifier incorporates variables for prediction of acquiring an infection, a patient fall, nephrogenic systemic fibrosis, contrast induced nephropathy, other adverse events, or combinations thereof. There are multiple factors that influence the risk of a patient to acquire an infection. The known risk factors may be classified into patient, procedural and treatment factors. The known risk factors may also be determined from public health data which may or may not be augmented into a collection of electronic medical records. Patient factors include a poor state of health, thereby impairing the defense against bacteria, and advanced age or premature birth along with immunodeficiency (due to drugs, illness, or irradiation). Procedural factors include invasive devices, such as intubation tubes, catheters, surgical drains, and tracheotomy tubes, all of which bypass the body's natural lines of defense against pathogens. Treatment factors include use of immunosuppressant, antacid treatment, antimicrobial therapy and recurrent blood transfusions. For example, the strongest single risk factor for hospital acquired candidemia found in a univariate analysis is the number of prior antibiotics administered. These variables and/or others are used for training. All, one, or a sub-set of these variables may be selected by the training for the classifier. Public data or public health factors may be societal factors such as area of residence or socioeconomic class.

The classifier is trained from a training data set using a computer. To prepare the set of training samples, the occurrence or not of an actual adverse event is determined for each sample (e.g., for each patient represented in the training data set). Any number of medical records for past patients is used. By using example or training data for tens, hundreds, or thousands of examples with known adverse event status, a processor may determine the interrelationships of different variables to the occurrence of the adverse event. The training data is manually acquired or mining is used to determine the values of variables in the training data. The training may be based on various criteria, such as the occurrence of the adverse event within a time period (e.g., only during the patient stay or within hours, days, weeks, months or years of discharge or other association with a medical entity).

The training data is for the medical entity for which the patient specific probability predictor will be applied. By using data for past patients of the same medical entity, the variables or feature vector most relevant to the adverse event for that entity are determined. The data for past patients may be augmented with data derived from public health data for a population or category. Different variables may be used by a machine-trained classifier for one medical entity than for another medical entity. Some of the training data may be from patients of other entities, such as using half or more of the examples from other entities with similar adverse event concerns, sizes, or patient populations. The training data from the specific institution may skew or still result in a different machine-learnt classifier for the entity than using fewer examples from the specific institution. In alternative embodiments, all of the training data is from other medical entities, or the patient specific probability predictor is trained in common for a plurality of different medical entities.

The classifier may be trained to predict based on different time periods, such as the adverse event occurring within 30 days or after 1 year from a likely cause (e.g., operation, injection of contrast agent, prescription of medication or other cause) or other event (e.g., admission, clinical action, or discharge). In alternative or additional embodiments, the patient specific probability predictor is programmed, such as using physician knowledge or the results of studies. For example, a semi-supervised or supervised training is used. As another example, the patient specific probability predictor is programmed using logic without machine training.

The classifier is trained to predict the adverse event in general, such as one patient specific probability predictor trained to predict any or two or more adverse events. Alternatively, separate classifiers are trained for different types of adverse events, such as training a classifier for predicting infections and training a separate classifier for predicting patient falls. In another alternative, only one classifier for one type of adverse event is trained.

The learnt patient specific probability predictor is a matrix. The matrix provides weights for different variables of the feature vectors and links with nodes. The values for the feature vector are weighted and combined based on the matrix. The patient specific probability predictor is applied by inputting the feature vector to the matrix. Other representations than a matrix may be used.

For application, the patient specific probability predictor is applied to the electronic medical record of a patient, which may or may not be augmented with data derived from public health data for a population or category. In response to the triggering, the values of the variables used by the learned classifier are obtained, such as populating by mining. The values are input to the patient specific probability predictor as the feature vector. The patient specific probability predictor outputs a probability of the adverse event of the patient based on the patient's current electronic medical record.

The probability of the adverse event is determined automatically. The user may input one or more values of variables into the electronic medical record, but the prediction is performed without entry of values after the trigger and while applying the patient specific probability predictor. Alternatively, one or more inputs are provided, such as resolving ambiguities in values or to select an appropriate classifier (e.g., select a patient specific probability predictor of infection as opposed to for trauma).

By applying the patient specific probability predictor to mined information for a patient, a probability of the adverse event is predicted for that patient. The machine-learnt or other classifier outputs a statistical probability of the adverse event based on the values of the variables for the patient. Where the prediction occurs in response to a patient event, such as triggering at the request of a medical professional or administrator, the probability is predicted for that time. The probability may be predicted at other times, such as when further information is obtained.

The patient specific probability predictor predicts the risk of the adverse event. For example, the patient specific probability predictor predicts the risk of acquiring an infection, of the patient falling, of contrast induced illness (e.g., nephrogenic systemic fibrosis or contrast induced nephropathy), of adverse reaction to treatment or drugs, of psychotic episode, of cardiac arrest, of seizure, of aneurism, of stroke, of a blood clot, of other trauma, of other side effect, or combinations thereof. For example, a probability value for the risk of a patient falling is generated. The probability may be based on the past and current medical records of a patient. The input feature may include variables such as whether the patient has nocturia or frequent urination and is currently on narcotics for pain, the combination of which render the patient at high risk to fall. Other variables may be used, such as genotype information for susceptibility or even treating physician. Data based variables outside clinical study information may indicate risk for one medical entity as compared to another.

The classifier may indicate one or more values contributing to the probability. For example, the failure to prescribe aspirin is identified as being the strongest link or contributor to a probability of the adverse event (e.g., heart attack) for a given patient being beyond a threshold. This variable and the value of the variable (e.g., no aspirin prescribed) are identified. The machine-learnt classifier may include statistics or weights indicating the importance of different variables to the adverse event and/or the normal. In combination with the values, some weighted values may more strongly determine an increased probability of adverse event. Any deviation from a norm may be highlighted. For example, a value or weighted value of a variable a threshold amount different from the norm or mean is identified. The difference alone or in combination with the strength of contribution to the probability is considered in selecting one or more values as more significant. The more significant value or values may be identified.

The prediction may be made during the patient stay. The prediction may be repeated at different times during the patient stay. The prediction may be made at the time of admission, such as the day of admission. The prediction may be updated, such as made before clinical action and updated after clinical action based on any data entered after the original prediction.

The probability generated by the patient specific probability predictor may be from 0% to 100%. Likely, the probability is greater than 0% and less than 100% due to missing information, unknowns, the classifier model using a restricted or limited set of variables, the nature of medical data, variance between medical entities and/or physicians in diagnosis or treatment, and/or other reasons. Any resolution may be provided for the probability, such as an integer from 0-100 or to the nearest tenth or hundredth decimal place.

Broader stratification may be provided. The probability of adverse events is compared to one or more thresholds to establish risk. The thresholds may be any probability based on national standards, local standards, medical entity standards, or other criteria. The medical entity may set the thresholds to customize their definition of low, medium or high risk patients. For example, the medical entity sets a threshold to distinguish a probability of the adverse event that is unusually high for that medical entity, for a similar class of medical entities, for entities in a region, for a rate important to reimbursement, or other grouping or consideration.

The comparison may be used to identify a patient for which further action may help reduce the probability of the adverse event. The comparison may be used to place the patient in a range for risk. The output probability value may be used to classify the patient into different subgroups, such as high, medium, or low risk of adverse event. Different actions may result for different levels of risk.

In addition, appropriate quantification of severity (Low, Medium and High) may be used to reflect the stratification of risk. A different classifier or the same classifier weights the probability by the type of adverse event. For more serious complications or adverse events, a lesser probability may still be quantified as higher severity.

In alternative embodiments of creating and applying the patient specific probability predictor, the prediction of the adverse event is integrated as a variable to be mined. The inference component determines the probability based on combination of probabilistic factoids or elements. The probability of adverse event is treated as part of the patient state to be mined. Domain knowledge determines the variables used for combining to output the probability of adverse event.

A user may be requested to enter additional information to help improve adverse event rates in general, such as the user reconciling different prescriptions, scheduling a test, resolving discrepancies in the electronic medical record, resolving a lack of adherence to a guideline, completing documentation in the electronic medical record, or arranging for a clinical action. A user also may be requested to accept a value proposed based on a category risk model. The system may output a list of variables that can be considered to reduce the risk of the adverse event, such as outputting values and variables for values of the feature vector that are a standard deviation or other difference from a norm. At least one variable having a value for the patient associated with a strong, stronger, or strongest link to the probability is output. For example, a patient has an unusually high measured blood characteristic, indicating a possible infection. This high value may be the most significant reason for a probability of the adverse event above a threshold. Most significant or significant may be based on the weight for the variable and the value in determining the probability or be based on a combination of factors (e.g., the relative strength or weight and the amount of deviance from a threshold). The strength of the link may be relative to links for other values of other variables to the risk of the adverse event. One or more reasons for the risk of the adverse event are identified. Alternatively, all of the values for the feature vector are output with or without indication of contribution to the probability and/or deviation from the norm.

Recommendations may be made based on the identified variable, variables, proposed variables, or combination of variables. For example, based on the past and current medical records of a patient, it may be determined whether the personal health record of the patient has been updated or not with the current admission. Where the probability of the adverse event is based, at least in part, on old information, a recommendation to document or update the record is provided. Similarly, it may be highlighted whether the medications have been reconciled or not. The recommendations may be based on the probability rather than the variables, such as providing a standardized recommendation for avoiding a type of adverse event.

The recommendation is textual, such as providing instructions. Other recommendations may be visual. A visual representation of the relationship of the probability to the patient record may assist user understanding. The visual representation is output on a display or printed. The visual representation of the relationship links elements or factoids (variables) to the resulting risk of the adverse event. The values for the variables from a specific patient record are inserted. A pictorial representation of the contribution of different variables, based on the values, to the risk may assist the user in general understanding of how any conclusions are supported by inputs.

The visual representation shows the dependencies between the data and conclusions. The dependencies may be actual or imaginary. For example, a machine learning technique may be used. The relationship of a given input to the actual output may be unknown, but a statistical correlation may be identified by machine learning. To assist in user understanding, a relationship may be graphically represented without actual dependency, such as probability or relative weighting, being known.

The visual representation may have any number of inputs, outputs, nodes or links. The types of data are shown. The relative contribution of an input to a given output may be shown, such as colors, bold, or breadth of a link indicating a weight. The data source or sources used to determine the values of the variables may be shown (e.g., billing record, prescription database or others).

The probability of adverse event and/or variables associated with the probability of the adverse event for a particular patient may be used to determine a mitigation plan. The mitigation plan includes instructions, prescriptions, education materials, schedules, clinical actions, tests, or other information that may reduce the risk of the adverse event. The next recommended clinical actions or reminders for the next recommended clinical actions may be output so that health care personnel are better able to follow the recommendations.

A library of mitigation plans is provided. Separate plans may be provided for different reasons for possible adverse event, different variables causing a higher risk of adverse event, and/or different combinations of both. The plan or plans appropriate for a given patient are obtained and output. The mitigation plan may include recommendations specific to each variable for which the value was a top (e.g., top 5 variables) reason for the probability being high or above a threshold. The mitigation plan is generated by combining the recommendations. Alternatively, different mitigation plans are provided for different combinations of variables, such as where addressing one value may result in changes to another value of another variable.

The output may be automatically generated as orders, additional lab tests, or other procedures in order to verify patient risk. For example, the probability of contrast agent induced illness being beyond a threshold may be due to a rate or number of previous imaging sessions. The output may be an alert seeking verification of how often the patient has been recently scanned to potentially reduce problems due to excess radiation dose exposure. The output may be to verify eligibility of the patient for procedures with insurance providers if appropriate.

The output may be based on a criteria set for the medical entity. For example, the medical entity may set the threshold for comparison to be more or less inclusive of different levels of risk. As another example, the medical entity may select a combination of factors to trigger an alert, such as probability level and types of variables contributing to the probability level. If one variable causes the patient specific probability predictor to regularly and inaccurately predict a risk higher than the threshold amount, then patients with higher probability based just or mostly on that variable may not have an alert output or a different alert may be output.

The output may be treatment instructions for the patient and/or medical professional (e.g., treating and/or primary care physician). The instructions may include the mitigation plan. Alternatively or additionally, the instructions include the predicted probability. Patients or physicians may be more likely to take corrective or preventative actions where the probability of the adverse event is known. The instruction may indicate the difference in probability if a value is changed and by how much, showing benefit to change in behavior or performance of clinical or medical action. Recommendations may be made to mitigate the risks. The output is a mitigation plan to be performed during the patient's stay, but may be incorporated as discharge instructions to avoid the adverse event after discharge.

An optimal avoidance strategy (e.g., assigning a nurse to make sure that a patient does not go to the bathroom on their own to prevent falls, prescribing prophylactic anti-biotics to prevent infections, or avoiding use of a ventilator to prevent ventilator acquired pneumonia) may be provided in instructions or workflow. The avoidance strategy may be selected or determined based on the probability of the adverse event and/or the variables contributing to the probability of adverse event being beyond the threshold. For example, an anti-biotic is prescribed and isolation is provided for a probability further beyond the threshold (e.g., beyond another threshold in a stratification of risk), and just the anti-biotic is prescribed for a probability closer to the threshold (e.g., for a lower risk). As another example, the severity of the type of adverse event predicted is considered. The probability may be utilized to manage the care and suggest possible and alternative plans for optimal avoidance of the adverse event.

In another embodiment, a job entry in a workflow is automatically scheduled as a function of the probability. A computerized workflow system includes action items to be performed by different individuals. The action items are communicated to the individual in a user interface for the workflow, by email, by text message, by placement in a calendar, or by other mechanism.

The workflow job is generated for a case manager. The job entry may be made to avoid the adverse event. The job entry may be to update patient data, arrange for clinical action, update a prescription, arrange for a prescription, review test results, arrange for testing, schedule a follow-up, review the probability, review patient data, or other action to reduce the probability of the adverse event. For example, where a test is not scheduled during a patient stay and is not automatically arranged, arranging for the test may be placed as an action item in an administrator's, assistant's, nurse's, or other case manager's workflow. As another example, review of test results is placed in a physician's workflow so that appropriate action may be taken during the patient stay. This may occur, for example, where the patient specific probability predictor identifies a probability of the adverse event beyond the threshold due to missing information. The test is ordered to provide the missing information. A workflow action is automatically scheduled to examine the test results and take appropriate action to avoid the adverse event. Similarly, a workflow action may be scheduled before admission or after discharge to avoid a higher risk of the adverse event occurring during the stay or after discharge.

The workflow action item may be generated to review reasons for the adverse event after any adverse event. Where a patient has an adverse event, a retrospective analysis may be performed in an effort to identify what could or should have been done differently. A case manager, such as an administrator of a hospital, may predict the probability of the adverse event based on the data at a time before the adverse event occurred or review the saved probability. The instructions, workflow action items, or other use of the probability may be examined to determine if other action was warranted. Future workflow action items, instructions, physician education, or other actions may be performed to avoid similar reasons for the occurrence of the adverse event in other patients. A correlation study of patients subjected to the adverse event may indicate common problems or trends.

The workflow is a separate application that queries the results of the mining and/or prediction of probability of the adverse event. The workflow uses the results or is included as part of the patient specific probability predictor application. Any now known or later developed software or system providing a workflow engine may be configured to initiate a workflow based on data.

The workflow system may be configured to monitor adherence to the action items. Reminders may be automatically generated where an action item is due or past due so that health care providers are better able to follow the recommendations.

Other patient specific probability predictors or statistical classifiers may be provided. One example patient specific probability predictor is for compliance by the patient, administrator, physician, nurse, or other medical professional with instructions or workflow tasks. A level of risk (i.e., risk stratification) and/or reasons for risk are predicted. The ground truth for compliance may rely on patient surveys or questionnaires, occurrence of the adverse event mined from patient data, studies of patient data or other sources. The patient specific probability predictor for whether a patient or other will comply is trained from the training data. Different patient specific probability predictors may be generated for different groups, such as by type of condition or adverse event. The variables used for training may be the same or different than for training the patient specific probability predictor of the adverse event. The trained patient specific probability predictor of compliance may have a different or same feature vector as the patient specific probability predictor of the adverse event. Mining is performed to determine the values for training and/or the values for application.

The patient specific probability predictor for compliance is triggered for application at the time of treatment, admission, or when other instructions are given to the patient or medical professional, but may be performed at other times. The values of variables in the feature vector of the patient specific probability predictor of compliance are input to the patient specific probability predictor. The application of the patient specific probability predictor to the electronic medical record of the patient or patients of a medical entity results in an output probability of compliance by the patient or medical professional. The reasons for the probability being beyond a threshold or thresholds may also be output. For example, a doctor may have a large number of patients as compared to other doctors associated with lesser probabilities of having patients suffer adverse events. The variable resulting in an above normal probability of failure to comply may be identified for the medical professional.

The probability of compliance may be used to modify instructions and/or workflow action items. For example, the type of instructions or actions taken may be more intensive or thorough where the probability of compliance by the patient is low. As another example, a workflow action may be generated to provide a reminder where the risk of compliance by a medical professional is low.

An output is provided in act 412. The output is a function of the patient specific probability. The patient specific probability is used in a further workflow or output. For example, the patient specific probability causes a job or action item in a workflow in an effort to reduce the patient specific probability. As another example, the patient specific probability is used to recommend the type of clinical action, further testing, prescription, mitigation plan, discharge instructions, or other action.

This analysis may be performed in real time. If performed in real time, suggestions and/or corrections may be output based on the patient specific probability. The suggestions and/or corrections may reduce the risk in a timely manner. Retrospective analysis may establish the top reason or reasons for the patients at a particular institution medical entity to have adverse events and possibly suggest alternative workflows based on best clinical practices. In alternative embodiments, the probability or risk without further suggestions or corrections is output.

In one embodiment, an alert is generated based on the comparing of the patient specific probability to a threshold or thresholds. The alert is generated before arrival of the patient, during the patient stay, at the time of discharge (e.g., when a medical professional is preparing discharge papers), or other times. For example, an alert about the risk of acquiring the infection during a patient stay of the patient at the hospital is output. In one example, the alert about the risk of a contrast induced illness is output. As another example, an alert about the risk of a patient fall during the patient stay of the patient at the hospital. Similarly, an alert may be output based on the probability and one or more values contributing to the probability. The alert may highlight whether instructions have been given to the attending nurse for an assisted bathroom visit or implement bowel and bladder programs to decrease urgency and incontinence, possibly to mitigate the risk of a fall. In case of discrepancies, recommendations may be made to mitigate the risks. The care may be better managed with the suggestion of possible and/or alternative plans for optimal patient outcomes based on a probability.

The alert is sent via text, email, voice mail, voice response, or network notification. The alert indicates the level of risk of the adverse event, allowing mitigation when desired or appropriate. The alert is sent to the patient, family member, treating physician, nurse, primary care physician, and/or other medical professional. The alert may be transmitted to a computer, cellular phone, tablet, bedside monitor of the patient, or other device. The recipient of the alert may examine why the probability is beyond the threshold, determine changes in workflow to reduce the risk of adverse event for other patients, and/or take actions to reduce the risk for the patient for which the alert was generated. In an embodiment, the alert is displayed at a bedside monitoring device.

The alert indicates the patient and a risk of the adverse event. Other information may be provided alternatively or additionally, such as identification of one or more values and corresponding variables correlating with the severity or risk level and/or a mitigation plan.

In one embodiment, the alert is generated as a displayed warning while preventing entry of patient event or other information. The user is prevented from scheduling or entering other data where the probability of the adverse event and/or severity of the predicated adverse event are sufficiently high. In response to the user attempting to schedule or enter information associated with the patient, the alert is generated and the user is prevented from entering or saving the information. The prevention is temporary (e.g., seconds or minutes), may remain until the probability has been reduced or requires an over-ride from an authorized person (e.g. a case manager or an attending physician). The prevention may be for one type of data entry (e.g., scheduling) but allow another type (e.g., medication reconciliation or addition of patient events that have already occurred) to reduce the risk of the adverse event.

In an embodiment, an output may involve scheduling a job entry in a workflow for a case manager of a patient. The job entry may be an entry for a procedure determined to reduce the patient specific probability determined by a patient specific probability detector. The job entry may be determined to reduce the patient specific probability based on an analysis of electronic medical records of a plurality of patients of the medical entity.

In an embodiment, an output may involve a selection of job entries for a workflow, with each job entry of the selection determined to reduce the patient specific probability.

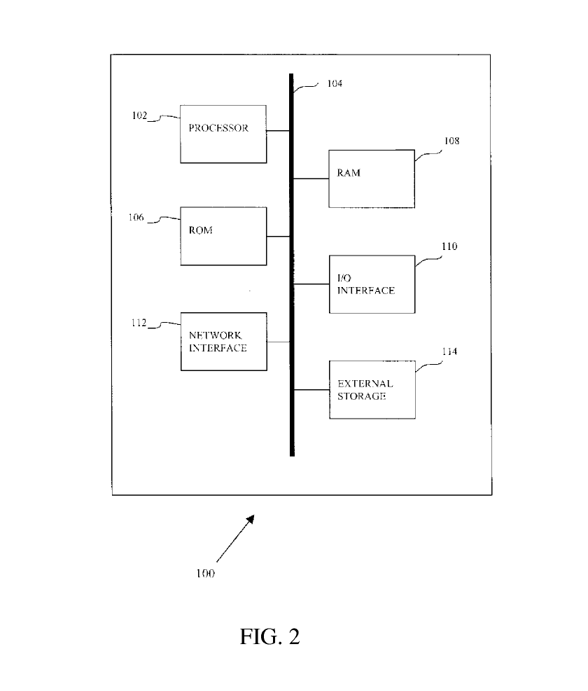

FIG. 2 is a block diagram of an example computer processing system 100 for implementing the embodiments described herein, such as preventing hospital or medical entity related adverse events. The systems, methods and/or computer readable media may be implemented in various forms of hardware, software, firmware, special purpose processors, or a combination thereof. Some embodiments are implemented in software as a program tangibly embodied on a program storage device. By implementing with a system or program, completely or semi-automated workflows, predictions, classifying, and/or data mining are provided to assist a person or medical professional.

The system 100 is for generating a patient specific probability predictor, such as implementing machine learning to train a statistical classifier. Alternatively or additionally, the system 100 is for applying the patient specific probability predictor. The system 100 may also implement associated workflows.

The system 100 is a computer, personal computer, server, PACs workstation, imaging system, medical system, network processor, or other now know or later developed processing system. The system 100 includes at least one processor (hereinafter processor) 102 operatively coupled to other components via a system bus 104. The program may be uploaded to, and executed by, a processor 102 comprising any suitable architecture. Likewise, processing strategies may include multiprocessing, multitasking, parallel processing and the like. The processor 102 is implemented on a computer platform having hardware such as one or more central processing units (CPU), a random access memory (RAM), and input/output (I/O) interface(s). The computer platform also includes an operating system and microinstruction code. The various processes and functions described herein may be either part of the microinstruction code or part of the program (or combination thereof) which is executed via the operating system. Alternatively, the processor 102 is one or more processors in a network and/or on an imaging system.

The processor 102 is configured to learn a classifier, such as creating a predictor of the adverse event from training data, to mine the electronic medical record of the patient or patients, and/or to apply a machine-learnt classifier to predict the probability of the adverse event. Training and application of a trained classifier are first discussed below. Example embodiments for mining follow.

For training, the processor 102 determines the relative or statistical contribution of different variables to the outcome, the occurrence of the adverse event. A programmer may select variables to be considered. The programmer may influence the training, such as assigning limitations on the number of variables and/or requiring inclusion or exclusion of one or more variables to be used as the input feature vector of the final classifier. By training, the classifier identifies variables contributing to the adverse event. Where the training data is for patients from a given medical entity, the learning identifies the variables most appropriate or determinative for the adverse events based on that medical entity. If the data from the patients of the medical entity is augmented with public health data, the classifier may identify even more variables. The public health data may be input as an aggregate value appropriate for the patient or using societal factors linked to patients (e.g., zip code). The training incorporates the variables into a predictor of the adverse event for a future patient of the medical entity.

For application, the processor 102 applies the resulting (machine-learned) statistical model to the data for a patient. For each patient or for each patient in a category of patients (e.g., patients treated for a specific condition or by a specific group within a medical entity), the predictor is applied to the data for the patient. The values for the identified and incorporated variables of the machine-learnt statistical model are input as a feature vector. A matrix of weights and combinations of weighted values calculates a probability of the adverse event.

The processor 102 associates different workflows with different possible predictions of the predictor. The probability of the adverse event, the probability of compliance, severity, and/or most determinative values may be different for different patients. One or a combination of these factors is used to select an appropriate workflow or action. Different predictions or probabilities of the adverse event may result in different jobs to be performed and/or different instructions.

The processor 102 is operable to assign actions or to perform workflow actions. For example, the processor 102 initiates contact for follow-up by electronically notifying a medical professional in response to identifying a probability of the adverse event, such as notifying a nurse or doctor to consider the probability in future instructions. As another example, the processor 102 requests documentation to resolve ambiguities in a medical record. In another example, the processor 102 generates a request for clinical action likely to decrease a probability of the adverse event. Clinical actions may include a test order, recommended action, request for patient information, other source of obtaining clinical information, prescription, or combinations thereof. To decrease a probability of the adverse event, the processor 102 may generate a prescription form, clinical order (e.g., test order), or other workflow action.

In a real-time usage, the processor 102 receives currently available medical information for a patient. The medical information may include information augmented by public data. Based on the currently available information and mining the patient record, the processor 102 may indicate how to mitigate risk of the adverse event. The actions may then be performed during the treatment or before discharge.

The processor 102 implements the operations as part of the system 100 or a plurality of systems. A read-only memory (ROM) 106, a random access memory (RAM) 108, an I/O interface 110, a network interface 112, and external storage 114 are operatively coupled to the system bus 104 with the processor 102. Various peripheral devices such as, for example, a display device, a disk storage device (e.g., a magnetic or optical disk storage device), a keyboard, printing device, and a mouse, may be operatively coupled to the system bus 104 by the I/O interface 110 or the network interface 112.

The computer system 100 may be a standalone system or be linked to a network via the network interface 112. The network interface 112 may be a hard-wired interface. However, in various exemplary embodiments, the network interface 112 may include any device suitable to transmit information to and from another device, such as a universal asynchronous receiver/transmitter (UART), a parallel digital interface, a software interface or any combination of known or later developed software and hardware. The network interface may be linked to various types of networks, including a local area network (LAN), a wide area network (WAN), an intranet, a virtual private network (VPN), and the Internet.

The instructions and/or patient record are stored in a non-transitory computer readable memory, such as the external storage 114. The same or different computer readable media may be used for the instructions and the patient record data. The external storage 114 may be implemented using a database management system (DBMS) managed by the processor 102 and residing on a memory such as a hard disk, RAM, or removable media. Alternatively, the storage 114 is internal to the processor 102 (e.g. cache). The external storage 114 may be implemented on one or more additional computer systems. For example, the external storage 114 may include a data warehouse system residing on a separate computer system, a PACS system, or any other now known or later developed hospital, medical institution, medical office, testing facility, pharmacy or other medical patient record storage system. The external storage 114, an internal storage, other computer readable media, or combinations thereof store data for at least one patient record for a patient. The patient record data may be distributed among multiple storage devices or in one location.

The patient data for training a machine learning classifier is stored. The training data includes data for patients that have had an adverse event and data for patients that have not has an adverse event after a selected time. The patients are for a same medical entity, group of medical entities, region, or other collection.

Alternatively or additionally, the data for applying a machine-learnt classifier is stored. The data is for a patient being treated or ready for discharge. The memory stores the electronic medical record of one or more patients. Links to different data sources may be provided or the memory is made up of the different data sources. Alternatively, the memory stores extracted values for specific variables.

The instructions for implementing the processes, methods and/or techniques discussed herein are provided on computer-readable storage media or memories, such as a cache, buffer, RAM, removable media, hard drive or other computer readable storage media. Non-transitory computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system. Because some of the constituent system components and method steps depicted in the accompanying figures are preferably implemented in software, the actual connections between the system components (or the process steps) may differ depending upon the manner in which the present embodiments are programmed.

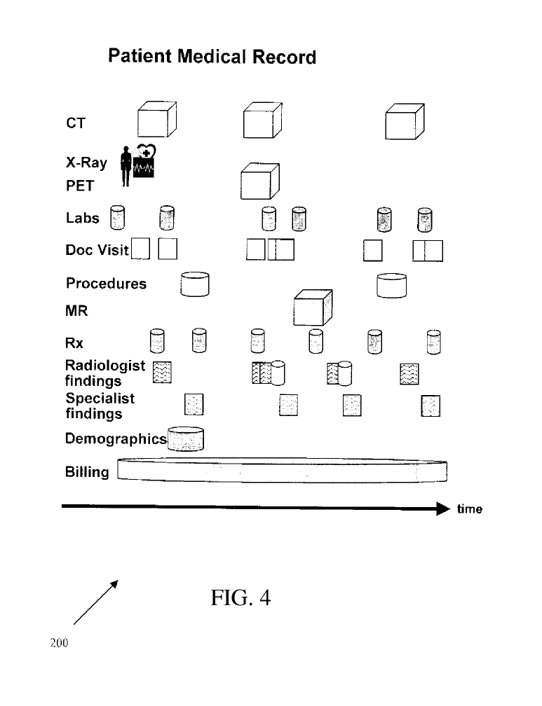

Health care providers may employ automated techniques for information storage and retrieval. The use of a computerized patient record (CPR) (e.g., an electronic medical record) to maintain patient information is one such example. As shown in FIG. 4, an exemplary CPR 200 includes information collected over the course of a patient's treatment or use of an institution. This information may include, for example, computed tomography (CT) images, X-ray images, laboratory test results, doctor progress notes, details about medical procedures, prescription drug information, radiological reports, other specialist reports, demographic information, family history, patient information, and billing (financial) information. Any of this information may provide for a societal factor, or data indicating a societal factor.

A CPR may include a plurality of data sources, each of which typically reflects a different aspect of a patient's care. Alternatively, the CPR is integrated into one data source. Structured data sources, such as financial, laboratory, and pharmacy databases, generally maintain patient information in database tables. Information may also be stored in unstructured data sources, such as, for example, free text, images, and waveforms. Often, key clinical findings are only stored within unstructured physician reports, annotations on images or other unstructured data source.

Referring to FIG. 2, the processor 102 executes the instructions stored in the computer readable media, such as the storage 114. The instructions are for mining and identifying societal risk factors from patient records (e.g., the CPR), predicting the adverse event, assigning workflow jobs, other functions, or combinations thereof. For training and/or application of the predictor of the adverse event, values of variables are used. The values for particular patients are mined from the CPR. The processor 102 mines the data to provide values for the variables.

In an embodiment, a memory, which may be the ROM 106, the RAM 108, or the external storage 114, is operable to store data for a plurality of patients of a medical entity. The processor 102 is configured to identify information of a patient related to a societal factor. The information may be identified through data mining. The processor 102 is also configured to categorize the patient based on the societal factor indicated by a category risk model as affecting a probability of an occurrence of an adverse event. The processor 102 is also configured to assign a category probability of the occurrence of the adverse event based on the category. The processor 102 is also configured to calculate a medical probability of an occurrence of the adverse event based on an electronic medical record of characteristics of the patient and data of other patients of the medical entity. The processor 102 is also configured to predict a patient specific probability of an occurrence of the adverse event to the patient based on the category probability and the medical probability.

In an embodiment, non-transitory computer readable storage medium, such as the ROM 106, the RAM 108, or the external storage 114, having stored therein data representing instructions executable by a programmed processor, such as 102, for predicting or preventing adverse events associated with a medical entity. The instructions include determining a category for a patient based on societal information of a patient. The instructions also include calculating a probability of an occurrence of an adverse event based on an electronic medical record of characteristics of the patient and data of a plurality of patients of the medical entity, each of the plurality being assigned to the category. The instructions also include comparing the probability to a threshold. The instructions also include generating an alert based on the comparing, the generating occurring during a patient stay with the medical entity.

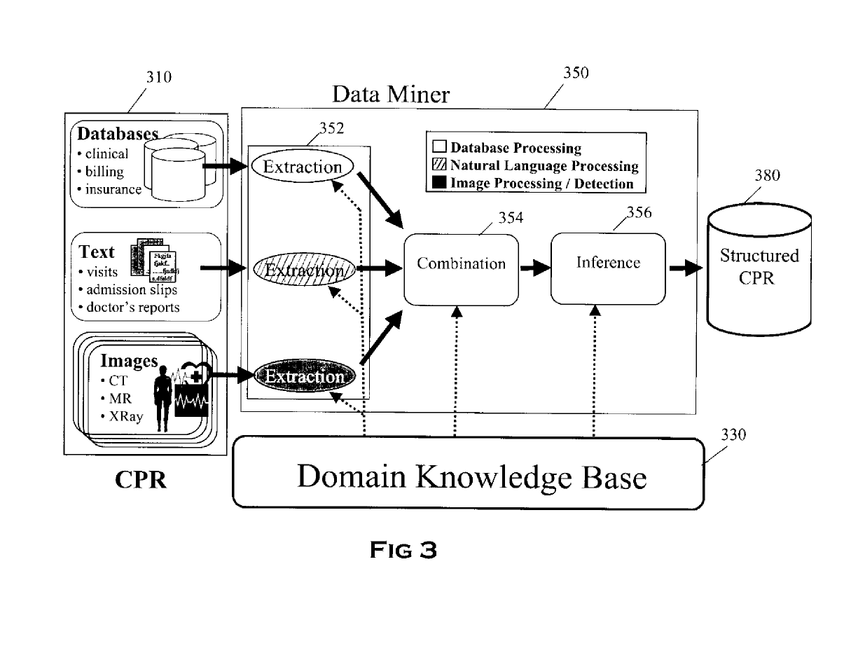

Any technique may be used for mining the patient record, such as structured data based searching. In one embodiment, the methods, systems and/or instructions disclosed in U.S. Published Application No. 2003/0120458 are used, such as for mining from structured and unstructured patient records. FIG. 3 illustrates an exemplary data mining system implemented by the processor 102 for mining a patient record to create high-quality structured clinical information. The clinical information may include information that indicates societal factors that are used to determine categories for patients based on public data for a generic population, or a combination of public and private data. The processing components of the data mining system are software, firmware, microcode, hardware, combinations thereof, or other processor based objects. The data mining system includes a data miner 350 that mines information from a CPR 310 using domain-specific knowledge contained in a knowledge base 330. The data miner 350 includes components for extracting information from the CPR 352, combining all available evidence in a principled fashion over time 354, and drawing inferences from this combination process 356. The mined information may be stored in a structured CPR 380. The architecture depicted in FIG. 4 supports plug-in modules wherein the system may be easily expanded for new data sources, diseases, and hospitals. New element extraction algorithms, element combining algorithms, and inference algorithms can be used to augment or replace existing algorithms.

The mining is performed as a function of domain knowledge. The domain knowledge provides an indication of reliability of a possible value based on the source or context. For example, a note indicating the patient is a smoker may be accurate 90% of the time, so a 90% probability is assigned. A blood test showing nicotine may indicate that the patient is a smoker with 60% accuracy, so a 60% probability is assigned.

Detailed knowledge regarding the domain of interest, such as, for example, a disease of interest, guides the process to identify relevant information. This domain knowledge base 330 can come in two forms. It can be encoded as an input to the system, or as programs that produce information that can be understood by the system. For example, a study determines factors contributing to the adverse event. These factors and their relationships may be used to mine for values. The study is used as domain knowledge for the mining. Additionally or alternatively, the domain knowledge base 330 may be learned from test data.

The domain-specific knowledge may also include disease-specific domain knowledge. For example, the disease-specific domain knowledge may include various factors that influence risk of a disease, disease progression information, complications information, outcomes, and variables related to a disease, measurements related to a disease, and policies and guidelines established by medical bodies. Similarly, the domain-specific knowledge may also include adverse event-specific domain knowledge.

The information identified as relevant by the study, guidelines for treatment, medical ontologies, machine-learnt classifier, or other sources provides an indication of probability that a factor or item of information indicates or does not indicate a particular value of a variable. The relevance may be estimated in general, such as providing a relevance for any item of information more likely to indicate a value as 75% or other probability above 50%. The relevance may be more specific, such as assigning a probability of the item of information indicating a particular diagnosis based on clinical experience, tests, studies or machine learning. Based on the domain-knowledge, the mining is performed as a function of existing knowledge, guidelines, or best practices regarding adverse events. The domain knowledge indicates elements with a probability greater than a threshold value of indicating the patient state (i.e., collection of values). Other probabilities may be associated with combinations of information.

Domain-specific knowledge for mining the data sources may include institution-specific domain knowledge. For example, information about the data available at a particular hospital, document structures at a hospital, policies of a hospital, guidelines of a hospital, and any variations of a hospital. The domain knowledge guides the mining, but may guide without indicating a particular item of information from a patient record.

The extraction component 352 deals with gleaning small pieces of information from each data source regarding a patient or plurality of patients. The pieces of information or elements are represented as probabilistic assertions about the patient at a particular time. Alternatively, the elements are not associated with any probability. The extraction component 352 takes information from the CPR 310 to produce probabilistic assertions (elements) about the patient that are relevant to an instant in time or period. This process is carried out with the guidance of the domain knowledge that is contained in the domain knowledge base 330. The domain knowledge for extraction is generally specific to each source, but may be generalized.

The data sources include structured and/or unstructured information. Structured information may be converted into standardized units, where appropriate. Unstructured information may include ASCII text strings, image information in DICOM (Digital Imaging and Communication in Medicine) format, and text documents partitioned based on domain knowledge. Information that is likely to be incorrect or missing may be noted, so that action may be taken. For example, the mined information may include corrected information, including corrected ICD-9 diagnosis codes.

Extraction from a database source may be carried out by querying a table in the source, in which case, the domain knowledge encodes what information is present in which fields in the database. On the other hand, the extraction process may involve computing a complicated function of the information contained in the database, in which case, the domain knowledge may be provided in the form of a program that performs this computation whose output may be fed to the rest of the system.

Extraction from images, waveforms, etc., may be carried out by image processing or feature extraction programs that are provided to the system.

Extraction from a text source may be carried out by phrase spotting, which requires a list of rules that specify the phrases of interest and the inferences that can be drawn there from. For example, if there is a statement in a doctor's note with the words “There is evidence of metastatic cancer in the liver,” then, in order to infer from this sentence that the patient has cancer, a rule is needed that directs the system to look for the phrase “metastatic cancer,” and, if it is found, to assert that the patient has cancer with a high degree of confidence (which, in the present embodiment, translates to generate an element with name “Cancer”, value “True” and confidence 0.9).

The combination component 354 combines all the elements that refer to the same variable at the same time period to form one unified probabilistic assertion regarding that variable. Combination includes the process of producing a unified view of each variable at a given point in time from potentially conflicting assertions from the same/different sources. These unified probabilistic assertions are called factoids. The factoid is inferred from one or more elements. Where the different elements indicate different factoids or values for a factoid, the factoid with a sufficient (thresholded) or highest probability from the probabilistic assertions is selected. The domain knowledge base may indicate the particular elements used. Alternatively, only elements with sufficient determinative probability are used. The elements with a probability greater than a threshold of indicating a patient state (e.g., directly or indirectly as a factoid), are selected. In various embodiments, the combination is performed using domain knowledge regarding the statistics of the variables represented by the elements (“prior probabilities”).

The patient state is an individual model of the state of a patient. The patient state is a collection of variables that one may care about relating to the patient, such as established by the domain knowledgebase. The information of interest may include a state sequence, i.e., the value of the patient state at different points in time during the patient's treatment.

The inference component 356 deals with the combination of these factoids, at the same point in time and/or at different points in time, to produce a coherent and concise picture of the progression of the patient's state over time. This progression of the patient's state is called a state sequence. The patient state is inferred from the factoids or elements. The patient state or states with a sufficient (thresholded), high probability or highest probability is selected as an inferred patient state or differential states.

Inference is the process of taking all the factoids and/or elements that are available about a patient and producing a composite view of the patient's progress through disease states, treatment protocols, laboratory tests, clinical action or combinations thereof. Essentially, a patient's current state can be influenced by a previous state and any new composite observations. The risk for the adverse event may be considered as a patient state so that the mining determines the risk without a further application of a separate model.

The domain knowledge required for this process may be a statistical model that describes the general pattern of the adverse event across the entire patient population and the relationships between the patient's adverse event and the variables that may be observed (lab test results, doctor's notes, or other information). A summary of the patient may be produced that is believed to be the most consistent with the information contained in the factoids, and the domain knowledge.

For instance, if observations seem to state that a cancer patient is receiving chemotherapy while he or she does not have cancerous growth, whereas the domain knowledge states that chemotherapy is given only when the patient has cancer, then the system may decide either: (1) the patient does not have cancer and is not receiving chemotherapy (that is, the observation is probably incorrect), or (2) the patient has cancer and is receiving chemotherapy (the initial inference—that the patient does not have cancer—is incorrect); depending on which of these propositions is more likely given all the other information. Actually, both (1) and (2) may be concluded, but with different probabilities.

As another example, consider the situation where a statement such as “The patient has metastatic cancer” is found in a doctor's note, and it is concluded from that statement that <cancer=True (probability=0.9)>. (Note that this is equivalent to asserting that <cancer=True (probability=0.9), cancer=unknown (probability=0.1)>).

Now, further assume that there is a base probability of cancer <cancer=True (probability=0.35), cancer=False (probability=0.65)> (e.g., 35% of patients have cancer). Then, this assertion is combined with the base probability of cancer to obtain, for example, the assertion <cancer=True (probability=0.93), cancer=False (probability=0.07)>.

Similarly, assume conflicting evidence indicated the following:

1. <cancer=True (probability=0.9), cancer=unknown probability=0.1)>

2. <cancer=False (probability=0.7), cancer=unknown (probability=0.3)>

3. <cancer=True (probability=0.1), cancer=unknown (probability=0.9)> and

4. <cancer=False (probability=0.4), cancer=unknown (probability=0.6)>.

In this case, we might combine these elements with the base probability of cancer <cancer=True (probability=0.35), cancer=False (probability=0.65)> to conclude, for example, that <cancer=True (prob=0.67), cancer=False (prob=0.33)>.

Numerous data sources may be assessed to gather the elements, and deal with missing, incorrect, and/or inconsistent information. As an example, consider that, in determining whether a patient has diabetes, the following information might be extracted:

(a) ICD-9 billing codes for secondary diagnoses associated with diabetes;

(b) drugs administered to the patient that are associated with the treatment of diabetes (e.g., insulin);

(c) patient's lab values that are diagnostic of diabetes (e.g., two successive blood sugar readings over 250 mg/d);

(d) doctor mentions that the patient is a diabetic in the H&P (history & physical) or discharge note (free text); and

(e) patient procedures (e.g., foot exam) associated with being a diabetic.

As can be seen, there are multiple independent sources of information, observations from which can support (with varying degrees of certainty) that the patient is diabetic (or more generally has some disease/condition). Not all of them may be present, and in fact, in some cases, they may contradict each other. Probabilistic observations can be derived, with varying degrees of confidence. Then these observations (e.g., about the billing codes, the drugs, the lab tests, etc.) may be probabilistically combined to come up with a final probability of diabetes. Note that there may be information in the patient record that contradicts diabetes. For instance, the patient has some stressful episode (e.g., an operation) and his blood sugar does not go up.

The above examples are presented for illustrative purposes only and are not meant to be limiting. The actual manner in which elements are combined depends on the particular domain under consideration as well as the needs of the users of the system. Further, while the above discussion refers to a patient-centered approach, actual implementations may be extended to handle multiple patients simultaneously. Additionally, a learning process may be incorporated into the domain knowledge base 330 for any or all of the stages (i.e., extraction, combination, inference).

The system may be run at arbitrary intervals, periodic intervals, or in online mode. When run at intervals, the data sources are mined when the system is run. In online mode, the data sources may be continuously mined. The data miner may be run using the Internet. The created structured clinical information may also be accessed using the Internet. Additionally, the data miner may be run as a service. For example, several hospitals may participate in the service to have their patient information mined, and this information may be stored in a data warehouse owned by the service provider. The service may be performed by a third party service provider (i.e., an entity not associated with the hospitals).

Once the structured CPR 380 is populated with patient information, it will be in a form where it is conducive for answering questions regarding individual patients, and about different cross-sections of patients. The values are available for use in predicting the adverse event.

The domain knowledgebase, extractions, combinations and/or inference may be responsive or performed as a function of one or more variables. For example, the probabilistic assertions may ordinarily be associated with an average or mean value. However, some medical practitioners or institutions may desire that a particular element be more or less indicative of a patient state. A different probability may be associated with an element. As another example, the group of elements included in the domain knowledge base for a predictor of the adverse event may be different for different medical entities. The threshold for sufficiency of probability or other thresholds may be different for different people or situations.

Other variables may be use or institution specific. For example, different definitions of a primary care physician may be provided. A number of visits threshold may be used, such as visiting the same doctor 5 times indicating a primary care physician. A proximity to a patient's residence may be used. Socioeconomic data derived from an address correlated to a socioeconomic category may be used. Combinations of factors may be used.

The user may select different settings. Different users in a same institution or different institutions may use different settings. The same software or program operates differently based on receiving user input. The input may be a selection of a specific setting or may be selection of a category associated with a group of settings.

The mining, such as the extraction, and/or the inferring, such as the combination, are performed as a function of the selected threshold. By using a different upper limit of normal for the patient state, a different definition of information used in the domain knowledge or other threshold selection, the patient state or associated probability may be different. User's with different goals or standards may use the same program, but with the versatility to more likely fulfill the goals or standards.

Various improvements described herein may be used together or separately. Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A method for predicting or preventing adverse events relating to a medical entity, the method comprising:
identifying, with a processor applying a category risk model, a societal factor associated with a patient;
assigning the patient to a category based on the societal factor;
determining a category probability of the occurrence of the adverse event based on the category;
determining, with the processor, a medical probability of an occurrence of the adverse event from an electronic medical record of characteristics of the patient, the determining being with a medical risk model, the medical probability based on adverse event data of other patients of the medical entity; and
determining, with the processor, a patient specific probability of an occurrence of the adverse event to the patient based on the category probability and the medical probability.

2. The method of claim 1, further comprising deriving the category risk model from publicly available data.

3. The method of claim 1, wherein identifying the societal factor of the patient comprises identifying residence information comprising at least a portion of an address of the patient.

4. The method of claim 1, wherein identifying the societal factor of the patient comprises determining wealth information comprising an income or a worth.

5. The method of claim 1, further comprising updating a field of the electronic medical record of the patient with information based on the category risk model as applied to a plurality of electronic medical records for patients of the medical entity.

6. The method of claim 5, wherein updating the field of the electronic medical record comprises updating the field with information based on an aggregated value determined for the field based on the category.

7. The method of claim 5, wherein updating the field of the electronic medical record comprises determining a value for the field of the electronic medical record based on machine learned graphical models.

8. The method of claim 1 further comprising:
automatically scheduling a job entry in a workflow of a case manager, the job entry for a procedure determined to reduce the patient specific probability.

9. The method of claim 8, further comprising identifying the procedure to reduce the patient specific probability based on an analysis of electronic medical records of a plurality of patients of the medical entity.

10. The method of claim 1 further comprising:
providing a selection of job entries for a workflow, each selection determined to reduce the patient specific probability.

11. The method of claim 1, wherein determining the patient specific probability of the occurrence of the adverse event to the patient is further based on relative weightings of the category probability and the medical probability.

12. The method of claim 1, wherein the category probability, the medical probability, and the patient specific probability are each values ranging from 0% to 100%.

13. A system for predicting or preventing adverse events, the system comprising:
at least one memory operable to store data for a plurality of patients of a medical entity; and
a first processor configured to:
identify information of a patient related to a societal factor;
categorize the patient based on the societal factor indicated by a category risk model as affecting a probability of an occurrence of an adverse event;
assign a category probability of the occurrence of the adverse event based on the category;
calculate a medical probability of an occurrence of the adverse event based on an electronic medical record of characteristics of the patient and data of other patients of the medical entity; and
predict a patient specific probability of an occurrence of the adverse event to the patient based on the category probability and the medical probability.

14. The system of claim 13, wherein the category risk model is derived from publicly available data.

15. The system of claim 13, wherein the information of the patient is residence information comprising at least a portion of an address of the patient.

16. The system of claim 13, wherein the first processor is configured to provide predicted medical record data for the patient based on the category assigned to the patient.

17. The system of claim 13, wherein the first processor is configured to automatically add a procedure determined to reduce the patient specific probability to a workflow of a case manager.

18. The system of claim 17, wherein the first processor is configured to identify the procedure as reducing the patient specific probability based on electronic medical records of a plurality of patients of the medical entity.

19. The method of claim 13 wherein the first processor is configured to provide a selection of job entries for a workflow, each selection determined to reduce the patient specific probability.

20. A non-transitory computer readable storage medium having stored therein data representing instructions executable by a programmed processor for predicting or preventing adverse events associated with a medical entity, the storage medium comprising instructions for:
determining a category for a patient based on a characteristic identified using patient information;
calculating a probability of an occurrence of an adverse event based on an electronic medical record of the patient and data of a plurality of patients of the medical entity, each of the plurality being assigned to the category;
comparing the probability to a threshold; and
generating an alert based on the comparing, the generating occurring during a patient stay with the medical entity.

21. The non-transitory computer readable storage medium of claim 20, wherein the information of the patient is residence information comprising at least a portion of an address of the patient.

22. The non-transitory computer readable storage medium of claim 20, wherein an existence of the category is determined using public information.

23. The non-transitory computer readable storage medium of claim 20, wherein generating the alert comprises broadcasting the alert to a mobile device.

24. The non-transitory computer readable storage medium of claim 20, wherein generating the alert comprises displaying the alert on a bedside monitoring device.

25. The non-transitory computer readable storage medium of claim 20, wherein the calculating comprises calculating the probability of an infection, a patient fall, nephrogenic systemic fibrosis, contrast induced nephropathy, or combinations thereof.

26. The non-transitory computer readable storage medium of claim 20, wherein the calculating comprises calculating the probability of readmission to the medical entity for the patient.
